(19) United States
(12) Patent Application Publication
(10) Pub. No.: US 2021/0026864 A1
(43) Pub. Date: Jan. 28, 2021

(54) DATA FORMAT PREPARING DEVICE, EDGE SERVER, AND DATA FORMAT PREPARING METHOD

(71) Applicant: FANUC CORPORATION, Minamitsuru-gun (JP)

(72) Inventors: Masao KAMIGUCHI, Yamanashi (JP); Yutaka SAITOU, Yamanashi (JP); Koji SAMUKAWA, Yamanashi (JP); Shigeru MORITA, Yamanashi (JP); Noriaki NEKO, Yamanashi (JP)

(21) Appl. No.: 16/896,656

(22) Filed: Jun. 9, 2020

(30) Foreign Application Priority Data
Jul. 26, 2019 (JP) 2019-138087

(51) Int. Cl. G06F 16/25

(52) U.S. Cl. CPC G06F 16/258; H04L 67/12

(57) ABSTRACT

To collect data collectable from edge equipment in a standard data format prepared by standardization. A data format preparing device 10 includes: a data dictionary storage unit 121 that stores a data dictionary 1211 containing the type and unit of collectable data for each type of the edge equipment 30; a data format storage unit 122 that stores a standard data format in which an edge server is to receive data from the edge equipment 30; a data format setting unit 111 that sets the standard data format on the basis of the data dictionary 1211 stored in the data dictionary storage unit 121; a data format examining unit 112 that examines the set standard data format; and a data format registering unit 113 that registers the standard data format with the data format storage unit 122.

This application is based on and claims the benefit of priority from Japanese Patent Application No. 2019-138087, filed on 26 Jul. 2019, the content of which is incorporated herein by reference.

### BACKGROUND OF THE INVENTION

### Field of the Invention

The present invention relates to a data format preparing device, an edge server, and a data format preparing method.

### Related Art

Efforts have been made in a production site such as collective management of information about various types of devices for “visualization” of a factory, identification of a cause using information about a plurality of devices in response to the occurrence of a problem at a production site such as an alarm, etc. Hence, what has been encouraged is to save information in chronological order about various types of devices in a production site such as industrial machines including machine tools and industrial robots, printing machines, measuring devices, etc., (hereinafter also called “edge equipment”) using an edge server communicably connected to these devices. Examples of such information include data indicating the working states of these pieces of edge equipment, data indicating a production state, data indicating the quality state of a product, and data indicating an operation state.

However, so far, with pieces of equipment manufactured by different manufactures, for example, pieces of data collected from these pieces of equipment have formats changing in various ways even if these pieces of data are of the same type. For example, there arises a difference in data format including a data name, a data digit number, a data unit, etc. In this way, in many conventional cases, methods of acquiring various types of data from the pieces of equipment have not been integrated. This makes it impossible to identify and refer to these pieces of data in an integrated manner to cause difficulty in managing information about various types of devices in a factory collectively such as those described above and organizing information appropriately necessary for “visualization” of the factor.

In this regard, according to a configuration disclosed in patent document 1, for example, a term dictionary configuration table is used for uniquely managing the attributes and digit numbers of terms of an identical concept as database components in an information processing system, and a term dictionary table is used for managing the attributes and digit numbers of database components, meanings of terms, etc. other than those managed by the term dictionary configuration table. Regarding a term intended to be managed in terms of an attribute and a digit number in an integrated manner using the term dictionary configuration table, the attribute and digit number of a corresponding database component are not managed in the term dictionary table but only link information to configuration information managed by the term dictionary configuration table is retained. By doing so, regarding an item managed by the term dictionary configuration table common to a database configuration managed by the term dictionary table, for example, the attribute and digit number of this data component in the term dictionary configuration table are corrected. As a result, the attribute and digit number of the database component managed in the term dictionary table can be changed in an integrated manner.

Patent Document 1: Japanese Unexamined Patent Application, Publication No. H11-073351

### SUMMARY OF THE INVENTION

However, the invention disclosed in patent document 1 is responsive to change in an integrated data format defined in a database using the term dictionary configuration table. However, patent document 1 does not disclose a method of acquiring various types of data from pieces of equipment of the same type manufactured by different equipment manufacturers, for example, and is not intended to achieve efficient collection of data collectable from a plurality of devices in a production site. Also, patent document 1 is not intended to provide an interface of a high degree of flexibility for efficiently collecting data collectable from an added device or a device subjected to change, for example.

Hence, even in the presence of a plurality of devices in a production site manufactured by different manufacturers, a data management system of a high degree of flexibility is desired that allows data collectable from devices of the same type to be identified in an integrated manner and to be collected efficiently.

(1) One aspect of this disclosure relates to a data format preparing device that sets a standard data format in which an edge server is to receive data collectable from a device connected to the edge server). The data format preparing device includes a control unit and a storage unit. The storage unit includes: a data dictionary storage unit that stores metadata containing the type of a device connectable to an arbitrary edge server and at least the type and unit of data collectable from the device for each type of the device; and a data format storage unit that stores a standard data format used for receiving data collectable from the device connected to the arbitrary edge server. The control unit includes: a data format setting unit that sets a standard data format for the edge server used for receiving data collectable from a device connected to the edge server on the basis of the metadata corresponding to the type of the device stored in the data dictionary storage unit; a data format examining unit that examines a format in the standard data format set by the data format setting unit; and a data format registering unit that registers the standard data format examined by the data format examining unit with the data format storage unit.

(2) One aspect of this disclosure relates to an edge server that collects data at a predetermined cycle from a device connected to the edge server on the basis of the standard data format set by the data format preparing device described in (1). The edge server includes a control unit. The control unit includes a data receiving unit that receives data collectable from the device at the predetermined cycle as a data string conforming to the type and unit of data defined in the standard data format.

(3) One aspect of this disclosure relates to a data format preparing method executed by a computer including: a data dictionary storage unit that stores metadata containing the type of a device connectable to an arbitrary edge server and at least the type and unit of data collectable from the device for each type of the device; and a data format storage unit. The method includes: a data format setting step of setting a standard data format for the edge server used for receiving data collectable from the device connected to the edge server on the basis of the metadata corresponding to the type of the device stored in the data dictionary storage unit; a data format examining step of examining a format in the standard data format set in the data format setting step; and a data format registering step of registering the standard data format examined in the data format examining step with the data format storage unit.

According to the one aspect, even in the presence of a plurality of devices in a production site manufactured by different manufacturers, a data management system of a high degree of flexibility can be provided that allows data collectable from devices of the same type to be identified in an integrated manner and to be collected efficiently.

### BRIEF DESCRIPTION OF THE DRAWINGS

FIG. 1 is a block diagram showing the configuration of a data management system according to an embodiment;

FIG. 2 shows an example of a data format setting screen (basic setting) provided by a data format preparing device according to the embodiment;

FIG. 3 shows an example of a data format setting screen (format setting) provided by the data format preparing device according to the embodiment;

FIG. 4 shows association between a data format set by the data format preparing device according to the embodiment and a record of collected data received in a standard data format prepared from the set data format;

FIG. 5 shows an example of a data dictionary according to the embodiment;

FIG. 6 shows an example of a screen presented first by the data format preparing device to a terminal in changing the standard data format according to the embodiment;

FIG. 7 shows an example of a confirmation screen appearing when examination of changed contents is finished in changing the standard data format according to the embodiment;

FIG. 8 shows an example of a test screen for checking data collected from the edge equipment 30 using a test environment 60 according to the embodiment;

FIG. 9 is a functional block diagram of an edge server according to the embodiment;

FIG. 10 shows an example of an installation management screen about the standard data format installed on the edge server according to the embodiment;

FIG. 11 shows an example of an event table according to the embodiment; and

FIG. 12 a processing flow diagram showing processing performed in collecting data from the edge equipment 30 connected to the edge server according to the embodiment.

### DETAILED DESCRIPTION OF THE INVENTION

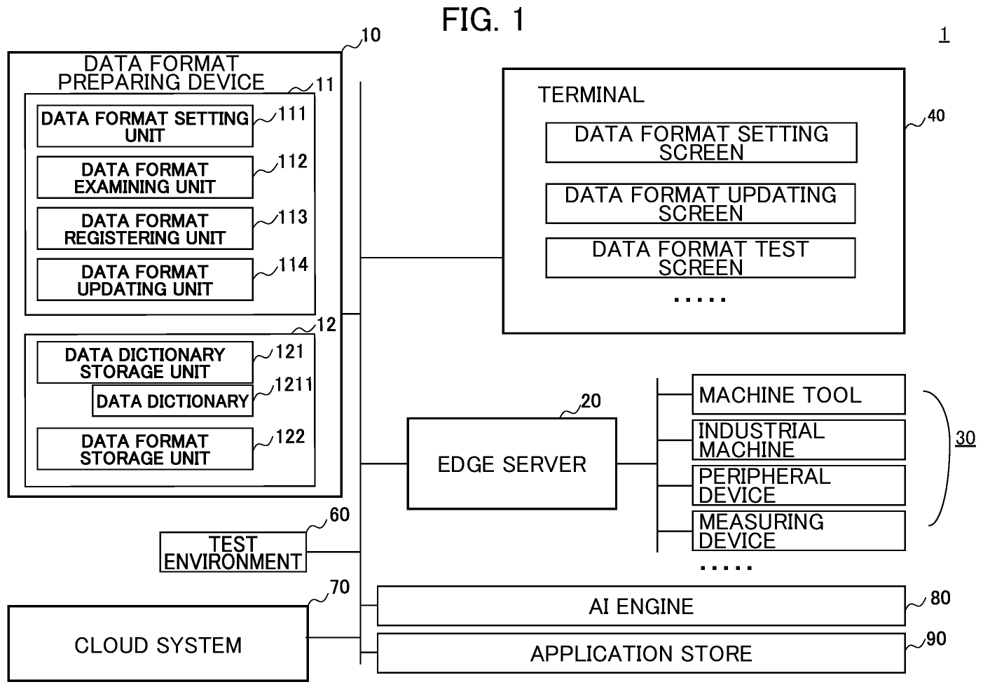

An example of an embodiment of the present invention will be described next. FIG. 1 is a block diagram showing the configuration of a data management system 1 according to the embodiment. The configuration of the data management system 1 mainly includes a data format preparing device 10, an edge server 20, edge equipment 30 as a device, a terminal 40, etc. The data management system 1 may additionally include a test environment 60, a cloud system 70, an AI engine 80, an application store 90, etc. First, an entire configuration of the data management system 1 will be described briefly by referring to FIG. 1.

The data format preparing device 10 prepares a standard data format used for receipt in a data format independent of a manufacturer in receiving data collectable from arbitrary edge equipment 30 connected to the edge server 20. More specifically, if a device connected to the edge server 20 is a computerized numerical controller (CNC), for example, the data format preparing device 10 allows receipt in a standard data format standardized independently of a manufacturer when the edge server 20 is to receive data collectable from the CNC such as information including a machine type, a product number, the number of a program currently executed, the number of axes used, a parameter for operating each axis, a velocity command for implementation of operation, a load torque, a current position, etc.

By using the standard data format set by the data format preparing device 10, the edge server 20 receives data collectable from the edge equipment 30 at each predetermined cycle, for example, as a data string independent of a manufacturer and conforming to the type (a data name indicating a data type, for example) and unit of data defined as a standard. As an example, a cell controller is applicable to the edge server 20.

As an example, the edge equipment 30 includes various types of devices in a production site connected to the edge server 20 such as industrial machines including machine tools, industrial robots and injection molding machines, peripheral devices such as transport vehicles or conveyors, and measuring devices, etc.

The terminal 40 is a client terminal connected to the data format preparing device 10. The terminal 40 is used for inputting a parameter for setting the standard data format via a screen provided by the data format preparing device 10. The terminal 40 may be input/output means (an input unit and a display unit, for example) provided to the data format preparing device 10.

The test environment 60 is an environment for testing data received from a device responsive to the standard data format set by the data format preparing device 10, for example.

The cloud system 70 is a system including a database for saving data collected in the standard data format at the edge server 20 from each edge equipment 30, for example. The cloud system 70 may include a knowledge generating functional unit that extracts a feature quantity about an event on each occurrence of an event such as an alarm, for example, to generate knowledge information using data collected from each edge equipment. More specifically, formation of an AI configuration in a factory can be encouraged as follows, for example. On the occurrence of an event such as an alarm, data relating to the alarm or data relating to a situation before or after the occurrence of the alarm is saved. Then, for each occurrence of an event such as an alarm, a feature quantity about the event is extracted, and information at the time of identification of a cause for the alarm (knowledge information) is added, thereby summarizing device information as knowledge linked to information about the event such as the alarm. To achieve this, the cloud system 70 may be connected to the AI engine 80 or the application store 90, for example.

The AI engine 80 mentioned herein is a tool used for analyzing a cause for an error, a method of handling the error, etc. in response to the occurrence of an alarm at the edge equipment 30 using knowledge information, etc. generated by the cloud system 70 (knowledge information functional unit, for example). By doing so, it becomes possible to provide the error cause, the method of handling the error, etc. to the edge server 20 or the edge equipment 30.

The application store 90 provides the edge server 20 with an application program having an interface for using the AI engine 80 (knowledge providing program, for example) as a package, for example. As a specific example, the application store 90 may provide the edge server 20 with data API to be run at the edge server 20, or sell such data API to the edge server 20. The application store 90 is configured as a website, for example. By selling the foregoing application program (knowledge providing program, for example), a user to purchase the application program is charged and a person having generated the knowledge information can get compensation for the generated knowledge information. The main part of the data management system 1 has been described above briefly. The data format preparing device 10 and the edge server 20 as principal constituting elements of the data management system 1 will be described next in detail.

### <Data Format Preparing Device 10>

The data format preparing device 10 includes a control unit 11 and a storage unit 12, and additionally includes various types of input/output devices and communication interfaces. The control unit 11 may fulfill each function of the embodiment by executing predetermined software (data format setting tool, data format examining program, data format registration) stored in the storage unit 12, for example. A Web system may be configured including the data format preparing device 10 as a Web server and the terminal 40 as a Web terminal. The control unit 11 includes the following as functional units relating to setting and registration of a standard data format described later: a data format setting unit 111, a data format examining unit 112, a data format registering unit 113, and a data format updating unit 114. These functional units will be described later.

In addition to a program storage unit (not shown) storing the various types of software described above, the storage unit 12 includes a data dictionary storage unit 121 and a data format storage unit 122.

### [Data Dictionary Storage Unit 121]

The data dictionary storage unit 121 stores metadata 1211 (also called “data dictionary 1211”) as a standardized type of the edge equipment 30 independent of a manufacturer for each type of edge equipment 30 connectable to an arbitrary edge server 20. The metadata 1211 includes at least the standardized data type (hereinafter also called “data name”) and unit of data collectable from this edge equipment 30. The data name may include a Japanese name, and additionally, include a name for program reference to be referred to by a program described later to use this data. The data unit may be a digit number set in response to the unit. More specifically, the type of the edge equipment 30 is set as key information. Next, the type of data collectable from the edge equipment 30 is set in response to the type of this edge equipment 30. If the type of the edge equipment 30 is a machine tool, for example, examples of a standardized data name for the machine tool include a main program number, the number of a program being executed, a tool number, a tool offset value, an M code number, an S code number, a T code number, the number of axes n, a current position of an nth axis, a velocity command for the nth axis, a disturbance load torque of the nth axis, override of the nth axis, and an nth axis motor temperature. The data dictionary storage unit 121 stores these standardized data names together with corresponding units for each type of edge equipment 30. Regarding arbitrary edge equipment 30 manufactured by a manufacturer, a correspondence between each data name indicating a data type depending on this manufacturer and a standardized data name for the type of this edge equipment 30 (hereinafter also called “data name correspondence table”) is provided by the manufacturer or a standardization operation and management department, for example. In this case, the data dictionary storage unit 121 may include the data name correspondence table prepared for edge equipment 30 manufactured by each manufacturer. As will be described later, the edge server 20 stores the data name correspondence table about each edge equipment 30 connected to the edge server 20.

### [Data Format Storage Unit 122]

The data format storage unit 122 stores a standard data format used for receiving data a user desires to collect from the edge equipment 30 connected to the edge server 20 as a data string independent of a manufacturer this edge equipment 30 and conforming to the name and unit of data defined as a standard in the data dictionary 1211. More specifically, the data format storage unit 122 stores a standard data format set and registered by the data format setting unit 111 described later, for example. The standard data format can also be used in referring to data received from the edge equipment 30 in an integrated database 221 of the edge server 20 storing this data.

As described above, the control unit 11 includes the data format setting unit 111, the data format examining unit 112, the data format registering unit 113, and the data format updating unit 114.

### [Data Format Setting Unit 111]

The data format setting unit 111 sets a standard data format in which the edge server 20 is to receive data collectable from the edge equipment 30 connected to the edge server 20 on the basis of the metadata (data dictionary 1211) corresponding to the type of the edge equipment 30 stored in the data dictionary storage unit 121. More specifically, the data format setting unit 111 provides the (client) terminal 40 with a data format setting screen prepared on the basis of the metadata. By doing so, the data format setting unit 111 sets the standard data format on the basis of data input from the terminal 40. This makes it possible to assign a standard data name or unit system to data collectable from the edge equipment 30 of the same type to achieve integration.

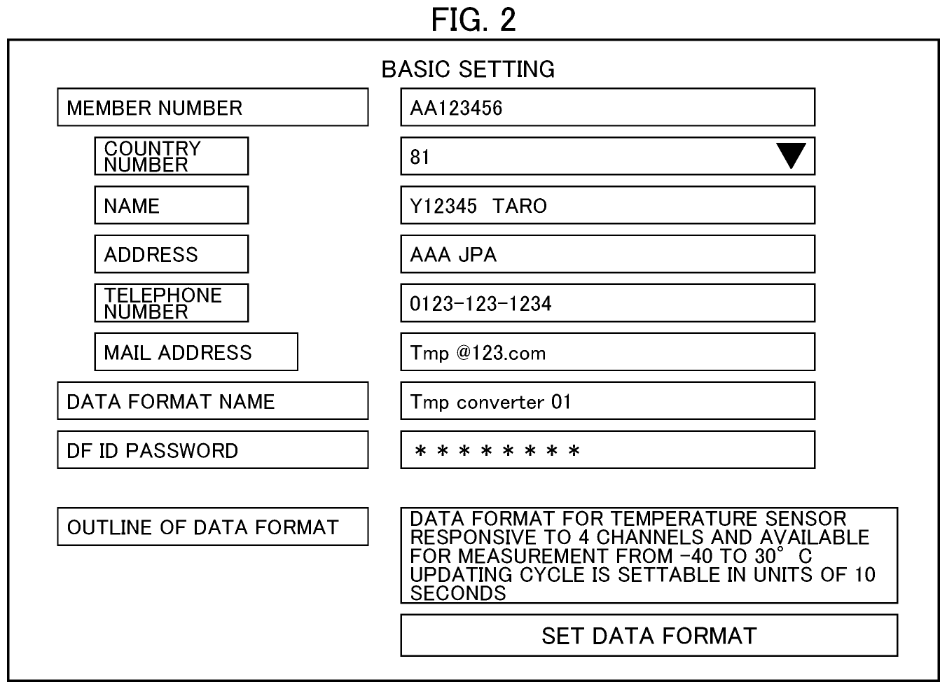

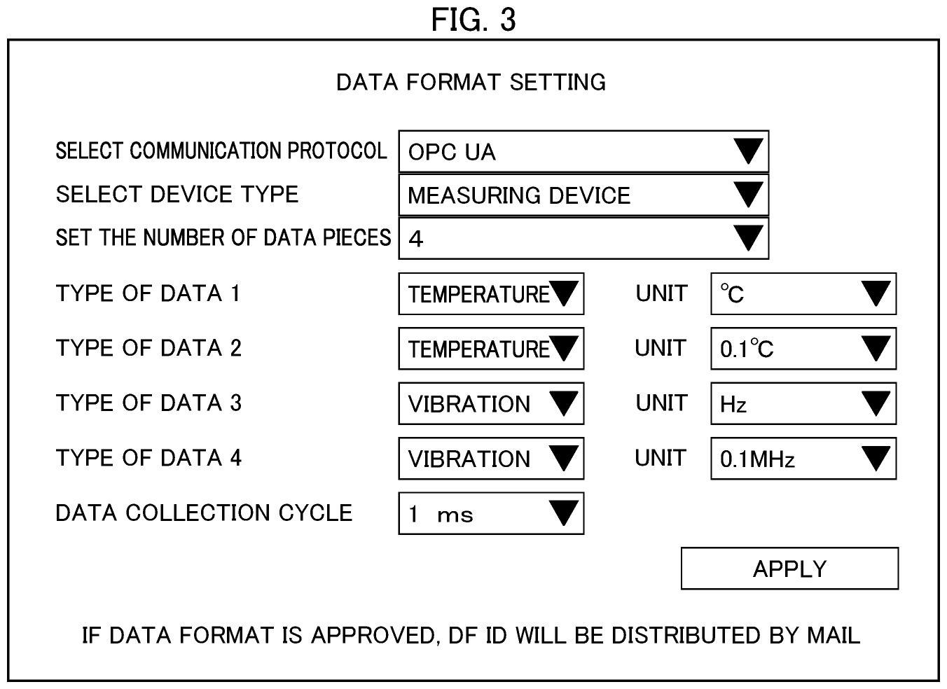

FIG. 2 shows an example of the data format setting screen (basic setting). FIG. 3 shows an example of the data format setting screen (format setting). As shown in FIGS. 2 and 3, data format setting includes basic setting and format setting. As described above, these screens are provided to the terminal 40 from the data format setting unit 111, for example. As an example, Web technology may be employed to provide these screens from the data format preparing device 10 as a Web server to the terminal 40.

### [Basic Setting]

As shown in FIG. 2, in making basic setting, information about a preparer of a data format (for example, a country number, the name, address, telephone number, and mail address) is input who is to access the data format setting unit 111 via the terminal 40. Further, the name of the data format to be prepared (also called “DF”), a password for DF_ID described later, and an outline of the data format are also set.

As shown in FIG. 2, a country number included in the information about the preparer of the data format is selectable in a menu format from country number list data in a data dictionary. If the preparer of the data format is registered with the data management system 1, a country number, the name, address, telephone number, and mail address of the preparer of the data format can be replaced with a registered member number of this preparer. Incorporating a country number in the basic setting allows handling of DF_ID on a country-by-country basis. In this case, while DF_ID is set in such a manner as to avoid overlap for the same standard data format in the same country, making a check to avoid overlap of DF_ID between two different countries becomes omissible.

As an example, the name of a data format to be set may be a name associated with an outline of processing relating to the data format. Regarding a DF_ID password, a preparer of a data format is caused to input a DF_ID password only known to the preparer for safety in updating this data format, as will be described later. By doing so, the DF_ID password can be used for identifying a person allowed to update this data format. As described above, DF_ID is set in such a manner as to avoid overlap in the same country. More specifically, if examination by the data format examining unit 112 described later is passed, DF_ID is given uniquely by the data format setting unit 111. The given DF_ID may be notified to the preparer of the data format after registration of the data format, for example. The preparer of the data format may be notified of DF_ID by a method such as a PUSH system using a mail, for example. Alternatively, the preparer of the data format may be notified of DF_ID via the terminal 40.

As shown in FIG. 2, the outline of a data format may be prepared for showing the specification of the data format briefly. In this case, by causing an application developer who is to create an application using a data file prepared in a standard data format to refer to the outline of the data format, the application developer becomes capable of checking the outline of data stored in the data file. As a result, the application can be developed efficiently. The outline of the data format may include the detail of the specification of the same data format registered in a form such as an attached file. After all the items in the basic setting shown in FIG. 2 are set, the data format setting unit 111 proceeds to data format setting shown in FIG. 3.

### [Data Format Setting]

FIG. 3 shows an example of a data format setting screen (format setting). As shown in FIG. 3, in making format setting, the data format setting unit 111 encourages application of the following items: a protocol for communication between the edge server 20 and the edge equipment 30, the type of the edge equipment 30 (device type) to which a data format is to be applied, the number of pieces of data simultaneously collectable in a standard data format to be prepared on the basis of the data format, the type and unit of data to be received in the standard data format to be prepared on the basis of the data format, sorting order for the received data in the standard data format, and a data collection cycle.

The communication protocol may be OPC UA (registered trademark) or Ether CAT (registered trademark), for example. As shown in FIG. 3, the communication protocol is selectable from a list menu of communication protocols. At the time of receipt of data using the standard data format prepared on the basis of this data format, the edge server 20 can receive set data from the edge equipment 30 via the set communication protocol.

As described above, the type of the edge equipment 30 (device type) to which the data format is to be applied includes industrial machines including machine tools, industrial robots and injection molding machines, peripheral devices such as printing machines, transport vehicles and conveyors, and measuring devices, for example. As shown in FIG. 3, the type of the edge equipment 30 (device type) to which the data format is to be applied is settable through a list menu of the types (device types) of the edge equipment 30.

The number of pieces of data simultaneously collectable in the standard data format prepared on the basis of the data format, and the type and unit of data to be received in the standard data format depend on the type of the edge equipment 30 to which the data format is to be applied. For this reason, selection menus for the type and unit of data are switched on the data format setting screen (format setting) in response to the type of the selected edge equipment 30. As described above, the type of the edge equipment 30, and the corresponding type and unit of data are managed in the data dictionary 1211 in the data dictionary storage unit 121. Preferably, the data dictionary 1211 is made and updated by a system administrator, for example. If there arises a need for a new format or unit system in response to development of a new sensor, for example, a data format preparer makes contact with the system administrator. The system administrator examines the new format or unit system, and then registers the new format or unit system with the data dictionary 1211. In this way, the new format or unit system can become a subject of standardization. The configuration of the data dictionary 1211 will be described later.

The description of the data format setting screen (format setting) will be continued by referring back to FIG. 3. In the example shown in FIG. 3, a measuring device is selected as the type of the edge equipment 30 (device type). Here, it is assumed that a 4ch-sensor is connected to the measuring device. In response to selectin of the measuring device, the data format setting unit 111 outputs menus for setting the types and units of four pieces of data. Order for selecting the pieces of data basically corresponds to order for pieces of data in the standard data format prepared from the data format. Finally, the data format setting unit 111 sets a data collection cycle. When the database preparer inputs an application for the setting, the data format setting unit 111 can transfer the control to the data format examining unit 112 described later.

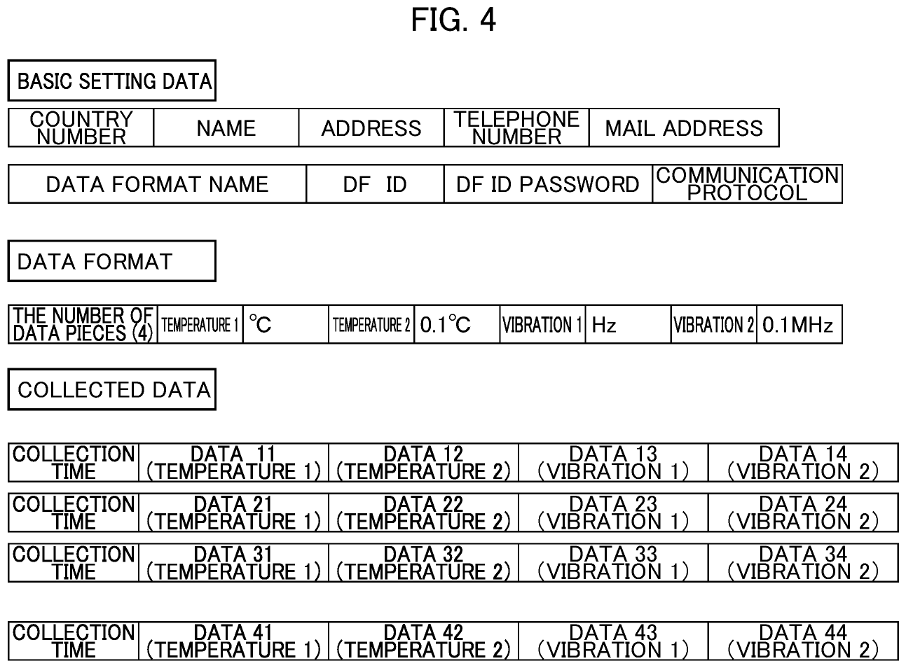

As described above, the type, unit, etc. of data forming the standard data format are to be selected uniquely in menu formats in response to a device type and on the basis of the data dictionary 1211. Thus, the type, unit, etc. of data can be shared without contradiction between devices of the same type. When the type or unit of data is selected, the data format setting unit 111 can link order for data in the standard data format to the type or unit of data corresponding to the selected order. By doing so, it becomes possible to retrieve necessary data in a record of collected data received in the standard data format using a data name. This technique is used conveniently for creating an application using data. For acquiring pieces of temperature data differing in DF_ID, for example, pieces of data of the same type can be acquired from different pieces of edge equipment 30 by designating DF_ID and designating a data type. FIG. 4 shows association between the data format setting made by the data format setting unit 111 and a record of collected data received in a standard data format prepared from the set data format. As shown in FIG. 4, sorting order for data stored in the record of collected data received at each data collection cycle is the same as sorting order for data names selected in the data format.

### [Data Dictionary 1211]

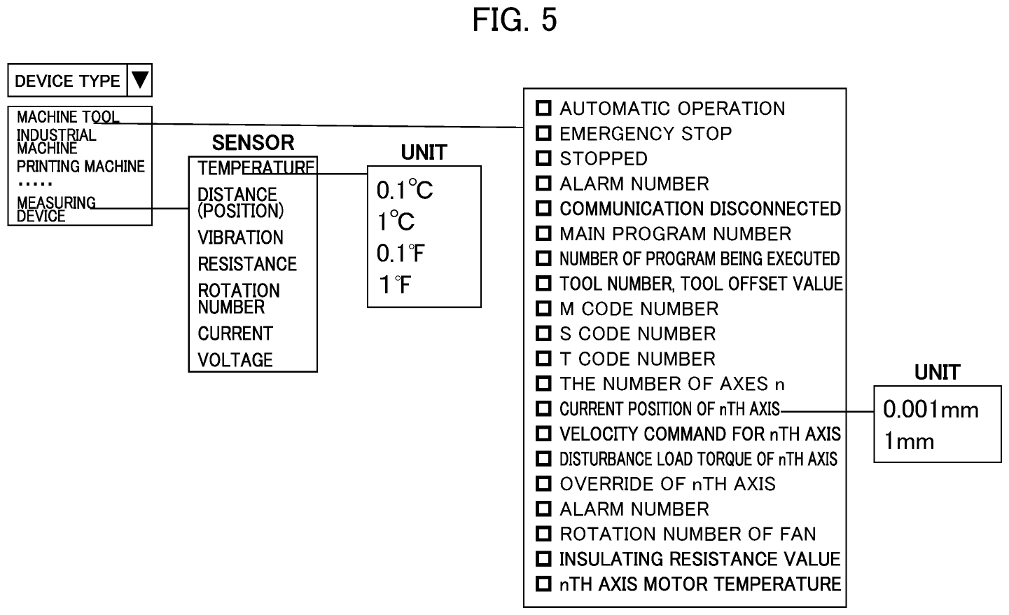

FIG. 5 shows an example of the data dictionary 1211. FIG. 5 shows an example of a data dictionary for managing the type of the edge equipment 30 as a subject of data format setting by the data format setting unit 111 described above, and the corresponding type and unit of data. As shown in FIG. 5, in the configuration of the data dictionary 1211, the type of the edge equipment 30 is in a high level (device type), and links to the type and unit of data available in response to a device type are prepared. If the configuration linking to the type and/or unit of data available in response to the type of the edge equipment 30 (device type) is updated, the edge equipment 30 itself may notify the content of the update to the data format preparing device 10 by making communication to cause the data format preparing device 10 to update the data dictionary 1211 on the basis of the notification. It is assumed, for example, that a new sensor is developed for the edge equipment 30 as measuring equipment in terms of a device type and the edge equipment 30 becomes capable of acquiring a temperature in units of 0.01° C. This may be notified from the edge equipment 30 itself to the data format preparing device 10 to cause the data format preparing device 10 to make update by adding 0.01° C. to a unit section linked if the device type shown in FIG. 5 is measuring equipment on the basis of the notification.

### [Data Format Examining Unit 112]

The data format examining unit 112 examines a format in a standard data format set by the data format setting unit 111. Further, the data format examining unit 112 makes a check for overlap between an applied data format, for example, and the standard data format already registered with the data format storage unit 122. If a result of the check shows the absence of a trouble, unique DF_ID is given to the applied data format. As described above, DF_ID may be notified to a preparer of the data format after registration of the data format.

### [Data Format Registering Unit 113]

The data format registering unit 113 registers the standard data format examined by the data format examining unit 112 with the data format storage unit 122. After registration with the data format storage unit 122, the standard data format is installed on an arbitrary edge server 20, thereby allowing receipt (collection) of a data string independent of a manufacturer and conforming to the name and unit of data set in the standard data format from the edge equipment 30 which connects to the edge server 20.

### [Data Format Updating Unit 114]

The data format updating unit 114 updates a standard data format set in and registered with the data dictionary storage unit 121. More specifically, if there arises a need to change the set and registered standard data format, the data format updating unit 114 certifies that a person having logged into the system is a person fulfilling a requirement allowing change of the standard data format. Then, the data format updating unit 114 provides a data format changing screen to the (client) terminal 40, for example, for causing the person to change the standard data format.

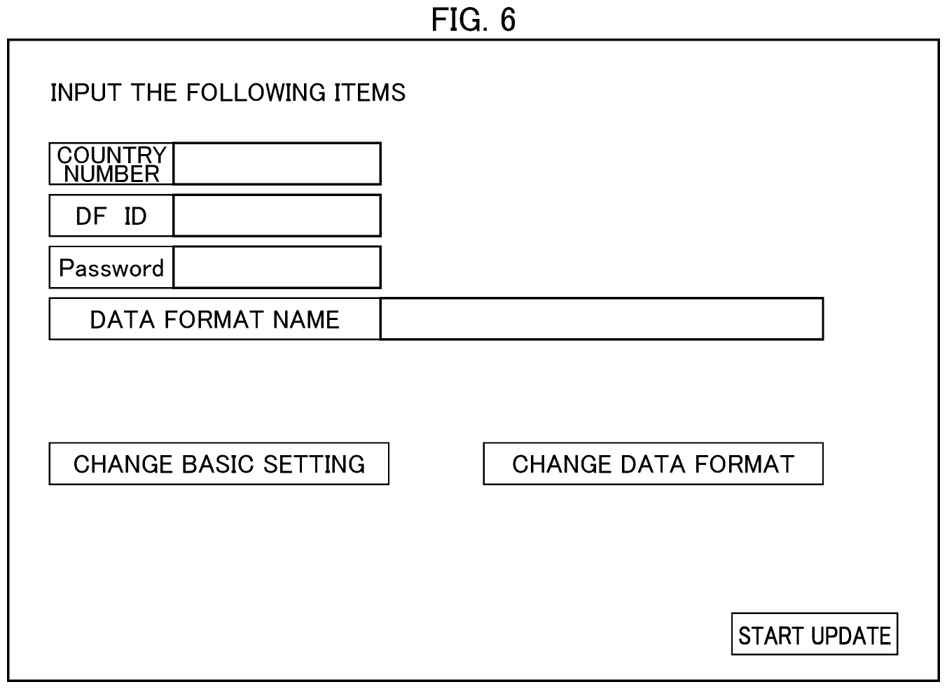

FIG. 6 shows an example of a screen presented first in changing the standard data format. The screen shown in FIG. 6 further functions as a screen to be output to the terminal 40 for certifying that a person having logged into the system is a person fulfilling a requirement allowing change of the standard data format. Before this screen is output, a log-in ID and a password for accessing the system have already been certified. As shown in FIG. 6, the data format updating unit 114 causes a user to input the following for identifying a data format to be changed: a country number, DF_ID, a DF_ID password, and the name of a data format. In particular, causing the user to input the DF_ID password only known to a preparer of the data format allows identification of a person allowed to update the data format. If the data format updating unit 114 judges that all the country number, DF_ID, the DF_ID password, and the name of the data format match corresponding items of the set and registered data format, the data format updating unit 114 can give permission to change the data format to the user.

As shown in FIG. 6, by causing the user to select either basic setting change or data format change, update on a selected item is started. For the update, the user may be caused to make input for the change while the set and registered content is displayed.

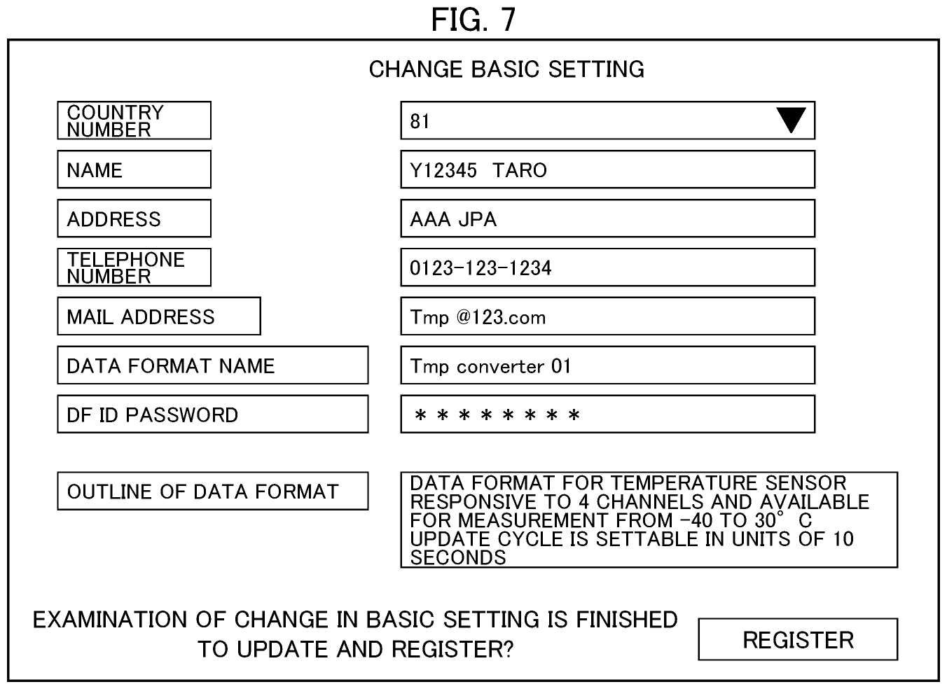

FIG. 7 shows an example of a confirmation screen appearing when the data format examining unit 112 finishes examination of the changed data format. As shown in FIG. 7, if there is changes in basic setting items, for example, the data format updating unit 114 may display all the changed basic setting items, cause the user to check these items again, and then cause the user to select registration. When registration is selected, the data format updating unit 114 becomes capable of updating and registering the standard data format stored in the data format storage unit 122. If the data format is updated, the data format updating unit 114 may give new DF_ID uniquely to the updated data format. If the new DF_ID is given, the data format updating unit 114 may cause the user to set a password for the new DF_ID. In another case, DF_ID itself may have version number information added in advance, and the data format updating unit 114 may update the version number information about DF_ID when the data format is updated. As the version number information, a first version, a second version, a third version, . . . may be expressed by serial numbers such as 01, 02, 03, . . . , or A, B, C, . . . , for example. If the version number information is added to DF_ID, the data format updating unit 114 may cause the user to set a password for each version number. If the data format is to be updated with the version number information added to DF_ID, the update is desirably made on the latest version.

### [Test Environment 60]

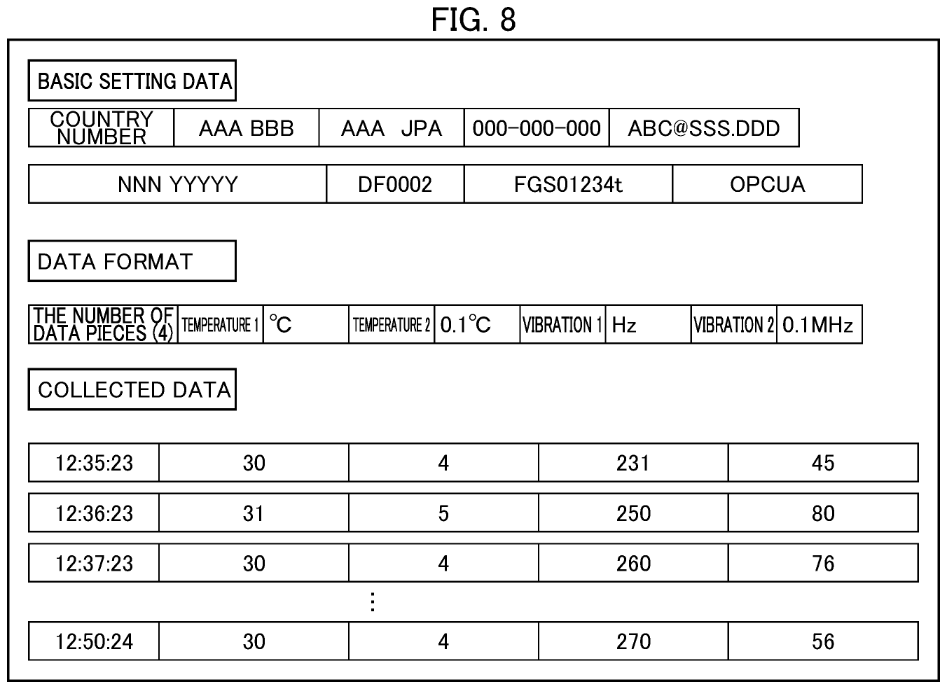

The data management system 1 may include the test environment 60 for testing data received from a device responsive to a standard data format set and registered by the data format preparing device 10. FIG. 8 shows an example of a test screen for checking data collected from the edge equipment 30 using the test environment 60. As shown in FIG. 8, basic setting data and a data format are displayed. Data strings collected from the edge equipment 30 are further displayed. By doing so, it becomes possible to easily determine whether the standard data format is correct. To use the test environment 60 effectively, a provisionally registered state for the standard data format may be set. The provisionally registered state mentioned herein means a state prohibiting the standard data format from being made available at an arbitrary edge server 20. As an example, a flag indicating the provisionally registered state may be provided in the data format storage unit 122. Setting and registration of the standard data format by the data format preparing device 10 is as has been described above.

The following effects are achieved by designing a device information database containing data collected from each edge equipment 30 on the basis of the data format preparing device 10. A unique device information database independent of a device information database designer can be designed. Even if pieces of the edge equipment 30 are different devices, pieces of information data of the same type can still be defined uniquely. Even if pieces of the edge equipment 30 have different data configurations, the device information database can still be defined using the number of data configurations necessary for the edge equipment. This achieves higher memory efficiency than a conventional method of defining all devices using the same number of data configurations. In developing application software for preparing and updating the device information database, data can be collected on the basis of a data name defined in a standard data format. This facilitates development of the application software for preparing and updating the device information database. Additionally, as data stored in the device information database can be referred to on the basis of the standard data format, application software for searching and referring to the device information database can be developed easily. This considerably increases productivity in developing application software relating to a device information database system. A data dictionary is used for managing the name, unit, etc. of data in an integrated manner forming a data format in the device information database. Thus, even if there arises a need to change the name and/or unit of data, the device information database containing this data can still be subjected to maintenance in an integrated manner. The following describes an embodiment showing the use of the standard data format at the edge server 20 prepared and registered in the foregoing manner.

### [Edge Server 20]

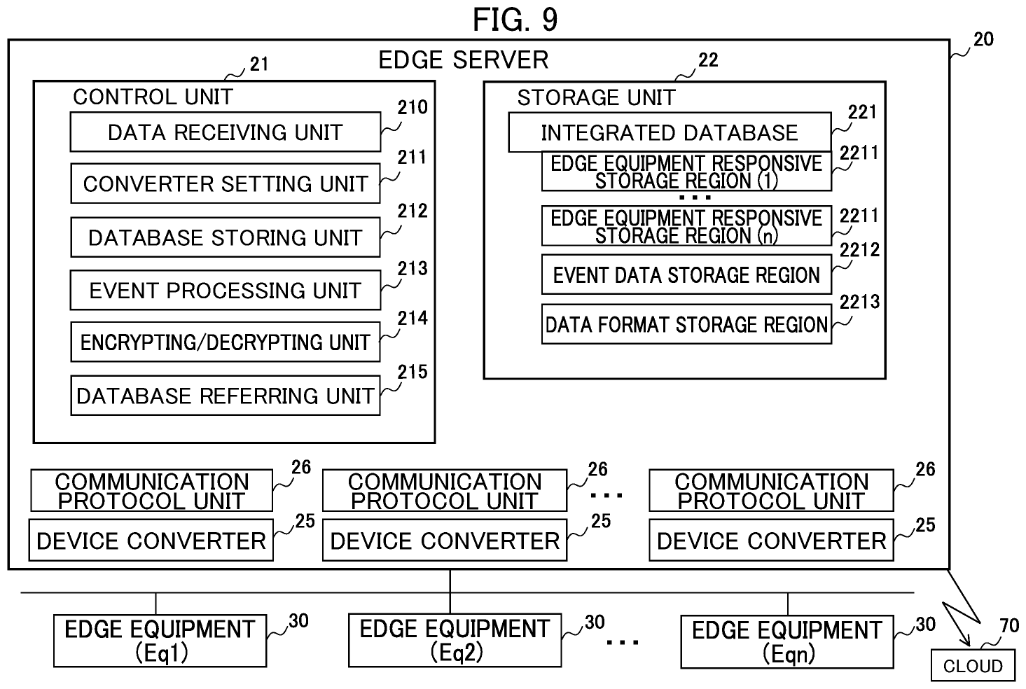

FIG. 9 is a functional block diagram of the edge server 20. As shown in FIG. 9, the edge server 20 includes a control unit 21 and a storage unit 22, and further includes a device converter 25 and a communication protocol unit 26. The device converter 25 and the communication protocol unit 26 will be described before the control unit 21 and the storage unit 22.

As described above, at least one edge equipment 30 such as a machine tool, an industrial machine, a robot, a programmable logic controller (PLC) device, or measuring equipment such as a switch or a sensor is connected to the edge server 20. The edge equipment 30 connected to the edge server 20 may be connected to the edge server 20 physically by means of the device converter 25 allowing connection to the edge server 20 in terms of hardware.

At least one device converter 25 is provided for absorbing difference between hardware interfaces for corresponding pieces of edge equipment 30 such as I/O, RS232C, RS422, Ethernet (registered trademark), for example, and for connecting each edge equipment 30 communicably to the edge server 20. The device converter 25 may be provided for each edge equipment 30 to be independent of the edge server 20.

The edge server 20 transmits and receives data to and from the edge equipment 30 connected to the edge server 20 by using a communication protocol responsive to the edge equipment 30 via the communication protocol unit 26. At least one communication protocol unit 26 is provided for absorbing difference between protocols for inclusion of data.

The control unit 21 may realize each function of the embodiment by executing predetermined software (converter setting application, data transmitting/receiving program, encrypting/decrypting program, for example) stored in the storage unit 22. The control unit 21 includes the following functional units described later responsible for transmission and receipt of data to and from the edge equipment 30 (in particular, collection of data from each edge equipment 30), saving and management of collected data, event processing, and encryption/decryption: a data receiving unit 210, a converter setting unit 211, a database storing unit 212, an event processing unit 213, an encrypting/decrypting unit 214, and a database referring unit 215. These functional units will be described later.

The storage unit 22 includes a program storage unit (not shown) storing the various types of software described above, and additionally, includes the integrated database 221 as a database. The integrated database 221 stores data collected from each edge equipment 30 connected to the edge server 20. More specifically, the integrated database 221 can be used for accumulating each of measured data, operation data, etc. collected in the past at each data collection cycle of each edge equipment 30 on the basis of a standard data format. The data collected from each edge equipment 30 may be accumulated in an edge equipment responsive storage region 2211 corresponding to each edge equipment 30. In accumulating the collected data on the basis of the standard data format, the standard data format and DF_ID used in the data accumulation may be accumulated in associated with the collected data. In this case, standard data format during the data accumulation is associated with the collected data. Thus, even if the standard data format is updated, the collected data can still be read according the standard data format during the data accumulation. This is not the only way of reading the collected data according to the standard data format during the data accumulation in the presence of update to the standard data format. If a data format is updated and the updated data format is always given new DF_ID, for example, DF_ID during the data accumulation may be accumulated in association with the collected data. In this case, even if the standard data format is updated, the collected data can still be read according the standard data format during the data accumulation. If DF_ID itself has version number information added in advance and the version number information about DF_ID is always updated when the data format is updated, DF_ID with the version number information during the data accumulation may be accumulated in association with the collected data. In this case, even if the standard data format is updated, the collected data can still be read according the standard data format during the data accumulation. If an event set in advance in an event table described later has occurred at each edge equipment 30, the integrated database 221 can be used for accumulating various types of data (data set in the event table) about each edge equipment 30 to be collected according to an extraction item and an extraction method set in advance. Event data may be stored in an event data storage region 2212. The event data will be described in detail in the description of the event processing unit 213 given later. A data format storage region 2213 may further be provided for storing the standard data format installed on the edge server 20.

As described above, the control unit 21 includes the data receiving unit 210, the converter setting unit 211, the database storing unit 212, the event processing unit 213, the encrypting/decrypting unit 214, and the database referring unit 215.

### [Data Receiving Unit 210]

The data receiving unit 210 receives data collectable from each edge equipment 30 at a predetermined cycle set in advance. As described above, if an event set in advance in the event table has occurred, the data receiving unit 210 may receive various types of data (data set in the event table) about each edge equipment 30 to be collected according to an extraction item and an extraction method set in advance. In receiving data from each edge equipment 30, the data receiving unit 210 uses a standard data format set by the converter setting unit 211. This allows the data receiving unit 210 to receive collected data as a data string conforming to the type and unit of data defined in this standard data format. More specifically, the data receiving unit 210 may receive a data string depending on a manufacturer of the edge equipment 30 corresponding to a data string conforming to the type and unit of data defined in the standard data format from the edge equipment 30, and convert the received data to a data string standardized on the basis of the standard data format. Interconversion between a data format depending on a manufacturer of the edge equipment 30 and a data format standardized on the basis of the standard data format may be made on the basis of the data name correspondence table described above, for example. Alternatively, interconversion between a data format depending on a manufacturer of the edge equipment 30 and a data format standardized on the basis of the standard data format may be made using a data conversion API (also called “data converter”) (not shown) to support this interconversion. By doing so, the data receiving unit 210 can collect data collectable from the edge equipment 30 as a data string independent of a manufacturer and conforming to the name and unit of data defined as a standard.

### [Converter Setting Unit 211]

The converter setting unit 211 sets a standard data format used for converting data received by the edge server 20 from the edge equipment 30 to a data string based on the standard data format, and installs the standard data format on the edge server 20. Then, by applying the set/installed standard data format to data received from the edge equipment 30, the data receiving unit 210 becomes capable of receiving data collectable from the edge equipment 30 as a data string independent of a manufacturer and conforming to the name and unit of data defined in the standard data format. In setting the standard data format, the converter setting unit 211 may set the data conversion API (data converter) described above to support interconversion between a data format depending on a manufacturer of the edge equipment 30 and a data format standardized on the basis of the standard data format, for example. Then, by designating DF_ID of a standard data format corresponding to a device type of the edge equipment 30, the edge server 20 becomes capable of receiving a data string conforming to the name and unit of data according to this standard data format.

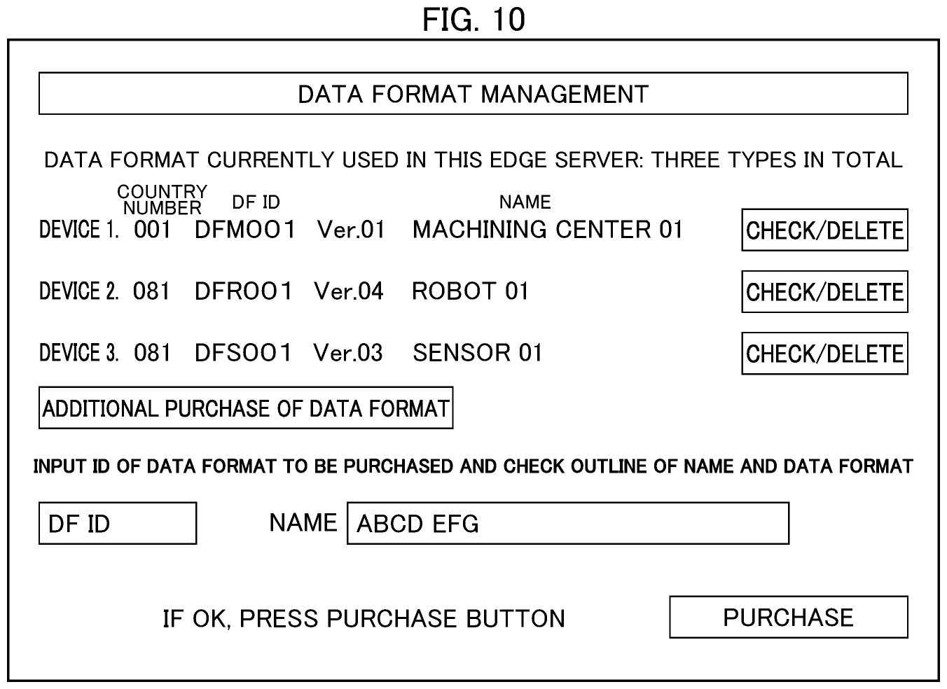

To facilitate check of a standard data format installed on the edge server 20 and available at the edge server 20, and additional purchase and deletion of the standard data format, the converter setting unit 211 may display a standard data format installation management interface (screen, for example) on a display unit (not shown) of the edge server 20, for example. This interface may be displayed on a terminal (not shown) communicably connected to the edge server 20. FIG. 10 shows an example of an installation management interface screen about standard data formats installed on the edge server 20. In FIG. 10, the standard data formats are illustrated as data formats for simplicity.

More specifically, as shown in FIG. 10, the converter setting unit 211 can display a list of standard data formats currently used at the edge server 20. Referring to the illustration in FIG. 10, three standard data formats are installed (set to be available) on the edge server 20. More specifically, the illustration is displayed in such a manner as to show that the following data format names are installed (set to be available): a data format name (machining center 01) of DF_ID (DFM001 Ver. 01) corresponding to a data format device 1, a data format name (robot 01) of DF_ID (DFR001 Ver. 04) corresponding to a device 2, and a data format name (sensor 01) of DF_ID (DFS001 Ver. 03) corresponding to a device 3. In response to press of a confirmation button, for example, the converter setting unit 211 can display a confirmation screen (not shown) for checking the content of a standard data format. On the confirmation screen for checking the content of a standard data format, a deletion button may be displayed in addition to description of the standard data format for checking the content thereof, for example. In this case, this standard data format can be deleted by causing a user to press this deletion button.

To additionally purchase a standard data format for newly connected edge equipment 30, a user inputs DF_ID and the name of the data format to be purchased and presses a purchase button. In response to this, the converter setting unit 211 may install this standard data format (sets this standard data format to be available) on the edge server 20. More specifically, in response to input of DF_ID by the user, the converter setting unit 211 displays a country number, name, etc. as attributes of the data format. The user checks these contents. If the user determines that the data format is to be added, the user presses the purchase button. In response to this, the converter setting unit 211 may download the purchased data format from the data format storage unit 122 of the data format preparing device 10. The converter setting unit 211 may extract a standard data format for the edge equipment 30 connected to the edge server 20 from standard data formats registered with the data format storage unit 122, and present a list of available standard data formats on the screen. Then, by causing the user to purchase an intended standard data format in the presented list, the converter setting unit 211 may download the purchased data format from the data format storage unit 122 of the data format preparing device 10. More specifically, the converter setting unit 211 may download a standard data format from the data format storage unit 122 of the data format preparing device 10 at the time of powering-on of the edge server 20 or when the standard data format is additionally purchased. The downloaded standard data format may be stored into the data format storage region 2213 in the integrated database 221. In response to update on a data format, the updated data format can be purchased as follows. If a data format is updated and given new DF_ID, or if version number information about DF_ID is updated, a user having purchased the data format before the update may be encouraged to purchase the updated data format newly. Alternatively, the updated data format may be made available to the user having purchased the data format before the update without being purchased newly.

### [Database Storing Unit 212]

The database storing unit 212 can store data collected from each edge equipment 30 connected to the edge server 20 into a storage region in the integrated database 221 corresponding to this edge equipment 30. More specifically, on the basis of a standard data format, the database storing unit 212 may accumulate measured data, operation data, etc. received at each data collection cycle set in advance by the data receiving unit 210 from each edge equipment 30 into a storage region (edge equipment responsive storage region 2211) in the integrated database 221 corresponding to this edge equipment 30. A database constructed in this edge equipment responsive storage region 2211 is also called a device information database, as described above.

### [Event Processing Unit 213]

As described above, if an event set in advance in the event table has occurred at the edge equipment 30, the event processing unit 213 can extract event log data from log data stored in the integrated database 221 according to an extraction item and an extraction method responsive to event occurrence set as parameters, and store the extracted event log data into the event data storage region 2212 in the integrated database 221. The event processing unit 213 may transmit the event log data to the cloud system 70. In response to this, in the cloud system 70, the knowledge generating functional unit (not shown) may extract a feature quantity about the event and generate knowledge information, for example. Data extracted on the occurrence of an event can also be collected as log data in advance using a standard data format.

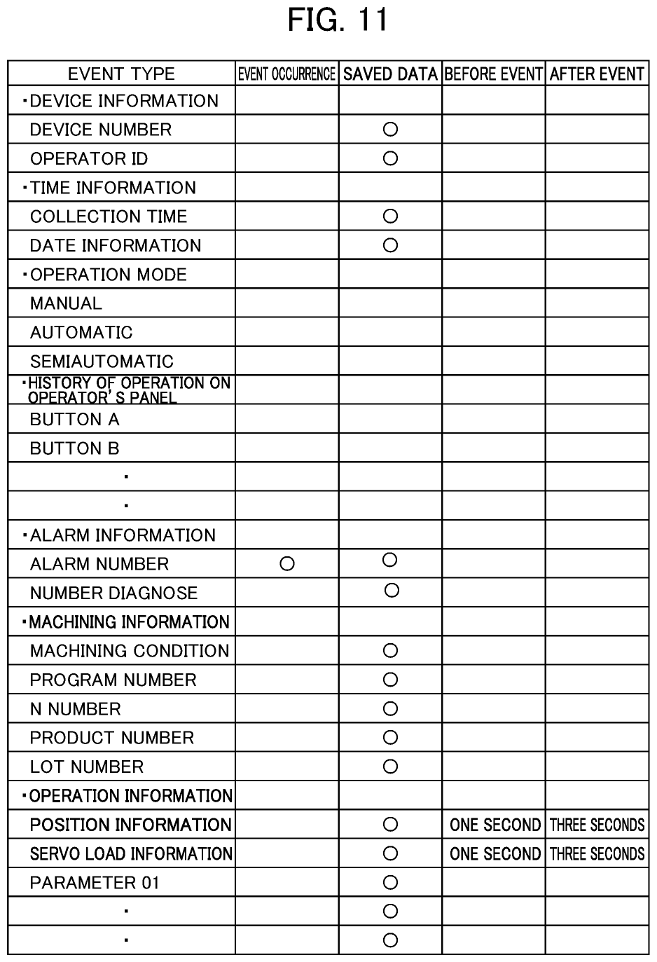

An event will be described below. FIG. 11 shows an example of the event table configured if the edge equipment 30 is a controller. Referring to FIG. 11, an alarm number is selected as a condition for event occurrence. For this reason, when an alarm is detected for the first time, the following pieces of data detected in a controller of the same cycle as a cycle of finding of the alarm are set to be collected at a resolution of an operating cycle: a device number, an operator ID, collection time, date information, an alarm number, number diagnose, a machining condition, a program number, an N number (processing number in a machining program being executed), a product number, a lot number, position information, servo load information, parameter 01, etc. Regarding each of the position information and the servo load information, setting is made further to collect data of the same cycle, past data dating back to a point one second before, and data about future occurrence in a period of three seconds after. In this case, on the occurrence of an alarm at the edge equipment 30, for example, the event processing unit 213 can extract event log data from the log data stored in the integrated database 221 under the foregoing set conditions, and store the extracted event log data into an event data storage unit of the integrated database 221. Further, the event processing unit 213 can transmit the event log data extracted from the integrated database 221 to the cloud system 70. As described above, storing event log data in a standardized data format can facilitate analysis of event data and can facilitate determination of a cause for the occurrence of the same alarm.

### [Encrypting/Decrypting Unit 214]

The encrypting/decrypting unit 214 encrypts data conforming to a standard data format received from the edge equipment 30 connected to the edge server 20 via the standard data format set by the converter setting unit 211, and transfers the encrypted data to the database storing unit 212. By doing so, the encrypting/decrypting unit 214 can store the encrypted data into the integrated database 221. A system for the encryption such as a common key system or a public key system is selectable in response to a degree of importance of data. In this way, the data received from the edge equipment 30 is encrypted immediately by the encrypting/decrypting unit 214, so that security against data leakage, etc. can be ensured. For accessing data in the integrated database 221, decrypting the encrypted data is required using the encrypting/decrypting unit 214. In this way, security of data collected from the edge equipment 30 can be ensured. Data in the integrated database 221 may be saved in the cloud system 70 in the form of encrypted data.

### [Database Referring Unit 215]

The database referring unit 215 refers to data (device information database) accumulated in the integrated database 221. An application in the edge server 20 can be used for referring to data collected from the edge equipment 30 and accumulated in the integrated database 221 via the database referring unit 215. More specifically, an API described below can be used for referring to data collected from arbitrary edge equipment 30, for example.

It is assumed, for example, that measured data is collected using the data format shown in FIG. 4 and accumulated in the integrated database 221. An API Get (device ID, country number, DF_ID, temperature 1, collection time) is used. In this case, data (temperature 1 data) collected at time closest to collection time designated by a parameter can be referred to. Here, a device ID is an ID for identifying the edge equipment 30 connected to the edge server 20, a country number is a number of a country where a data format was prepared, DF_ID is an ID of the data format, a temperature 1 is a value at a temperature sensor connected to the edge equipment 30 and indicated in units of ° C. In the illustration of FIG. 4, of pieces of temperature 1 data including data 11, data 21, data 31, data 41, . . . , reference is made to data of time closest to the collection time designated by the parameter.

The API can be configured in various formats. It is assumed, for example, that several pieces of data are desired to be acquired simultaneously. In this case, an API Get (device ID, country number, DF_ID, temperature 1, temperature 2, vibration 1, vibration 2, collection time) is used. By doing so, reference can be made to temperature 1 data, temperature 2 data, vibration 1 data, and vibration 2 data collected at time closest to collection time designated by a parameter.

It is assumed that reference is intended to be made to n pieces of data starting from predetermined collection time. In this case, an API Get (device ID, country number, DF_ID, temperature 1, collection time, n) is used. By doing so, reference can be made to n pieces of data starting from collection time (or time closest to the collection time) designated by a parameter. In the illustration of FIG. 4, of the pieces of temperature 1 data including data 11, data 21, data 31, data 41, . . . , reference can be made to n pieces of data starting from data of time closest to the collection time designated by the parameter. Instead of the number n, collection time as an end point may be designated as a parameter. As described above, data to be retrieved can be encrypted. In this case, the encrypted data is required to be decrypted.

As described above, using the data dictionary 1211 managed in the data dictionary storage unit 121 of the data format preparing device 10 and using the data format setting screens shown in FIGS. 2 and 3 provided by the data format setting unit 111 allows the edge server 20 to prepare a standard data format for data received from the edge equipment 30 connected to the edge server 20, and store a data group conforming to the prepared data format into the integrated database 221. In using data stored in the integrated database 221, the standard data format standardized independently of a manufacturer can be used for referring to such data.

Each of the data receiving unit 210, the converter setting unit 211, the database storing unit 212, the event processing unit 213, the encrypting/decrypting unit 214, and the database referring unit 215 may be provided with an API responsive to application software to be executed at the edge server 20, thereby making the function of each of these functional units available through the application software. By doing so, the device information database can be operated in an integrated manner to increase productivity in development and maintenance of application software to use the device information database.

### [Edge Equipment 30]

A plurality of devices (edge equipment 30) is connectable to the edge server 20. Each of these devices allows connection thereto of various types of devices such as a servo motor, a sensor, etc. Each of these devices transmits data to the edge server 20 via a data transmitting and receiving unit and a communication protocol not shown. Each of these devices can transmit data to the edge server 20 in response to a request from the edge server 20. The embodiment of the data management system 1 has been described above mainly on the basis of the configurations of the data format preparing device 10, the edge server 20, and the edge equipment 30.

### <Operation of Embodiment>

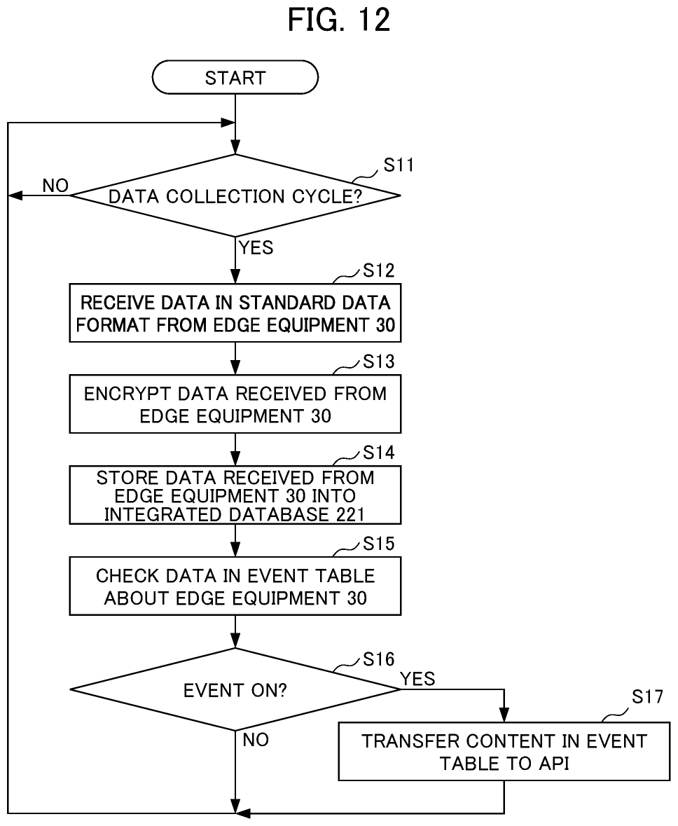

FIG. 12 a processing flow diagram showing processing performed in collecting data from the edge equipment 30 connected to the server 20 at a predetermined control cycle set in advance using a standard data format installed on the edge server 20. The processing flow shown in FIG. 12 is prepared for each standard data format applied to each edge equipment 30.

In step S11, the data receiving unit 210 judges whether timing for a data collection cycle set in the standard data format has come. If timing for the data collection cycle has come (if Yes), the flow goes to step S12. If timing for the data collection cycle has not come (if No), the flow returns to step S11.

In step S12, the data receiving unit 210 receives data from the edge equipment 30 set in the standard format as a data string conforming to the type and unit of the data defined in the standard data format.

In step S13, the encrypting/decrypting unit 214 encrypts the received data. In step S14, the database storing unit 212 stores the received data encrypted in step S13 into the edge equipment responsive storage region 2211 in the integrated database 221 corresponding to the edge equipment 30. A storage region corresponding to the standard data format may be formed further in the edge equipment responsive storage region 2211, and the received data may be stored into this storage region.

In step S15, the event processing unit 213 checks data set in an event table relating to the edge equipment 30. In step S16, the event processing unit 213 judges whether an event has occurred. If the event processing unit 213 judges that an event has occurred (if Yes), the flow goes to step S17. If the event processing unit 213 judges that an event has not occurred (if No), the flow goes to step S11.

In step S17, the event processing unit 213 transfers the contents in the event table to an API for implementation of processing responsive to event occurrence (as a specific example, an API for implementation of processing by a task different from data collection), for example. Then, the flow goes to step S11. The foregoing data collection may be done while the edge equipment 30 performs its processing, for example.

While the embodiment of the present invention has been described above, the present invention should not be limited to the foregoing embodiment. The effects described in the embodiment are merely a list of the most preferable effects resulting from the present invention. Effects achieved by the present invention should not be limited to those described in the embodiment.

In the foregoing embodiment, the cloud system 70 is described as an example of a system including a database for saving data collected in a standard data format at the edge server 20 from each edge equipment 30, for example. However, the cloud system 70 is not the only example. As an example, any computer system configured using the edge server 20 as a high-order system is applicable.

Each functional unit in the data management system 1 can be realized by software, as described above. To realize each functional unit by software, programs configuring the software are installed on a computer. These programs may be stored in various types of tangible storage media and then distributed to a user. Alternatively, these programs may be distributed by being downloaded to a computer of the user through a network.

### <Effects of Embodiment>

The embodiments of this disclosure will be listed below.

(1) According to the embodiment, the data format preparing device 10 is a device that sets a standard data format in which the edge server 20 is to receive data collectable from the edge equipment 30 connected to the edge server 20. The data format preparing device 10 includes the control unit 11 and the storage unit 12. The storage unit 12 includes: the data dictionary storage unit 121 that stores metadata containing the type of edge equipment 30 connectable to an arbitrary edge server and at least the type and unit of data collectable from the edge equipment 30 for each type of the edge equipment 30; and the data format storage unit 122 that stores a standard data format used for receiving data collectable from the edge equipment 30 connected to the arbitrary edge server. The control unit 11 includes: the data format setting unit 111 that sets a standard data format for the edge server 20 used for receiving data collectable from the edge equipment 30 connected to the edge server 20 on the basis of the metadata (data dictionary 1211) corresponding to the type of the edge equipment 30 stored in the data dictionary storage unit 121; the data format examining unit 112 that examines a format in the standard data format set by the data format setting unit 111; and the data format registering unit 113 that registers the standard data format examined by the data format examining unit 112 with the data format storage unit 122. As a result, if several pieces of edge equipment 30 at a production site are devices of the same type, data collectable from these devices can be collected in the standard data format standardized independently of a manufacturer.

(2) The data format preparing device 10 described in (1) may communicably be connected to the terminal 40, and the data format setting unit 111 may set the standard data format by providing a setting screen to the terminal 40 for causing the terminal 40 to set the standard data format. As a result, a user such as a database designer becomes capable of setting the standard data format easily.

(3) The data format preparing device 10 described in (1) may communicably be connected to the edge equipment 30, and the control unit 11 may update the metadata and store the updated metadata into the data dictionary storage unit 121 on the basis of notification from the edge equipment 30 notifying update information corresponding to the type of the edge equipment 30 in the metadata (data dictionary 1211) already stored in the data dictionary storage unit 121. As a result, if addition or update is made to the type and/or unit of data linking to the type of the edge equipment 30 in the data dictionary 1211, this update information is reflected automatically in the data dictionary 1211.

(4) According to the embodiment, the edge server 20 is a server that collects data at a predetermined cycle from the edge equipment 30 connected to the edge server 20 on the basis of the standard data format set by the data format preparing device 10 described in any one of (1) to (3). The edge server 20 may include the control unit 21. The control unit 21 may include the data receiving unit 210 that receives data collectable from the edge equipment 30 at the predetermined cycle as a data string conforming to the type and unit of data defined in the standard data format. As a result, the edge server 20 becomes capable of receiving data collectable from the edge equipment 30 connected to the edge server 20 in the standardized data format set by the data format preparing device 10 independently of a manufacturer of the edge equipment 30. Thus, even if edge equipment 30 is added or changed, the system relating to data collection can still be maintained and managed easily.

(5) The edge server 20 described in (4) may include the integrated database 221, and the control unit 21 may further include the database storing unit 212 that stores data received by the data receiving unit 210 into the integrated database 221. As a result, the integrated database 221 of the edge server 20 becomes capable of providing data collectable from the edge equipment 30 connected to the edge server 20 with a data configuration conforming to the standardized data format set by the data format preparing device 10 independently of a manufacturer of the edge equipment 30. This facilitates maintenance and management of the system relating to the database.

(6) In the edge server 20 described in (5), the control unit 21 may further include the database referring unit 215. On the basis of the standard data format, the database referring unit 215 refers to data in the integrated database 221 about designated edge equipment 30 stored in the integrated database 221 and collected from the designated edge equipment 30. As a result, the data in the integrated database 221 collected from each edge equipment 30 can easily be made available.

(7) In the edge server 20 described in (6), the database storing unit 212 may further be configured to encrypt data received from the edge equipment 30 at a cycle of the receipt and store the encrypted data into the integrated database 221, and the database referring unit 215 may further be configured to decrypt the encrypted data in the integrated database 221 collected from the edge equipment 30, and input the decrypted data from the integrated database 221. As a result, it becomes possible to ensure security of data about the edge equipment 30 connected to the edge server 20.

(8) The edge server 20 described in any one of (4) to (7) may include the converter setting unit 211 that sets a standard data format used for converting data received from the edge equipment 30 to a data string based on the standard data format, and the data receiving unit 210 may convert the data received from the edge equipment 30 to the data string based on the standard data format via the standard data format set by the converter setting unit 211. As a result, effect similar to that described in (4) is achieved.

(9) In the edge server 20 described in (6) or (7), the database referring unit 215 may be configured as a function of the control unit 21 by causing the edge server 20 to execute a data reference program prepared as an API. As a result, effect similar to that described in (6) is achieved.

(10) According to the embodiment, a data format preparing method is a method executed by a computer including: the data dictionary storage unit 121 that stores metadata (data dictionary 1211) containing the type of edge equipment 30 connectable to an arbitrary edge server 20 and at least the type and unit of data collectable from the edge equipment 30 for each type of the edge equipment 30; and the data format storage unit 122. The method causes the computer to execute: a data format setting step of setting a standard data format for the edge server 20 used for receiving data collectable from the edge equipment 30 connected to the edge server 20 on the basis of the metadata (data dictionary 1211) corresponding to the type of the edge equipment 30 stored in the data dictionary storage unit 121; a data format examining step of examining a format in the standard data format set in the data format setting step; and a data format registering step of registering the standard data format examined in the data format examining step with the data format storage unit 122. As a result, effect similar to that described in (1) is achieved.

### EXPLANATION OF REFERENCE NUMERALS

1 Data management system
10 Data format preparing device
11 Control unit
111 Data format setting unit
112 Data format examining unit
113 Data format registering unit
114 Data format updating unit
12 Storage unit
121 Data dictionary storage unit
1211 Data dictionary
122 Data format storage unit
20 Edge server
21 Control unit
210 Data receiving unit
211 Converter setting unit
212 Database storing unit
213 Event processing unit
214 Encrypting/decrypting unit
215 Database referring unit
22 Storage unit
221 Integrated database
25 Device converter
26 Communication protocol unit
30 Edge equipment
40 Terminal
60 Test environment
70 Cloud system
80 AI engine
90 Application store

What is claimed is:

1. A data format preparing device that sets a standard data format in which an edge server is to receive data collectable from a device connected to the edge server, the data format preparing device comprising:
a control unit; and
a storage unit,
the storage unit comprising:
a data dictionary storage unit that stores metadata containing the type of a device connectable to an arbitrary edge server and at least the type and unit of data collectable from the device for each type of the device; and
a data format storage unit that stores a standard data format used for receiving data collectable from the device connected to the arbitrary edge server,
the control unit comprising:
a data format setting unit that sets a standard data format for the edge server used for receiving data collectable from a device connected to the edge server on the basis of the metadata corresponding to the type of the device stored in the data dictionary storage unit;
a data format examining unit that examines a format in the standard data format set by the data format setting unit; and
a data format registering unit that registers the standard data format examined by the data format examining unit with the data format storage unit.

2. The data format preparing device according to claim 1, wherein the data format preparing device is communicably connected to a terminal, and
the data format setting unit sets the standard data format by providing a setting screen to the terminal for causing the terminal to set the standard data format.

3. The data format preparing device according to claim 1, wherein the data format preparing device is communicably connected to the device, and
the control unit updates the metadata and stores the updated metadata into the data dictionary storage unit on the basis of notification from the device notifying update information corresponding to the type of the device in the metadata already stored in the data dictionary storage unit.

4. An edge server that collects data at a predetermined cycle from a device connected to the edge server on the basis of the standard data format set by the data format preparing device according to claim 1, the edge server comprising:
a control unit,
the control unit comprising a data receiving unit that receives data collectable from the device at the predetermined cycle as a data string conforming to the type and unit of data defined in the standard data format.

5. The edge server according to claim 4, comprising:
a database, wherein
the control unit further comprises:
a database storing unit that stores data received by the data receiving unit into the database.

6. The edge server according to claim 5, wherein
the control unit further comprises a database referring unit, on the basis of the standard data format, the database referring unit referring to data in the database about a designated device stored in the database and collected from the designated device.

7. The edge server according to claim 6, wherein
the database storing unit is further configured to encrypt data received from the device at a cycle of the receipt and store the encrypted data into the database, and
the database referring unit is further configured to decrypt the encrypted data in the database collected from the device and input the decrypted data from the database.

8. The edge server according to claim 1, comprising a converter setting unit that sets a standard data format used for converting data received from the device to a data string based on the standard data format, wherein
the data receiving unit converts the data received from the device to the data string based on the standard data format via the standard data format set by the converter setting unit.

9. The edge server according to claim 6, wherein the database referring unit is configured as a function of the control unit by causing the edge server to execute a data reference program prepared as an API.

10. A data format preparing method executed by a computer comprising: a data dictionary storage unit that stores metadata containing the type of a device connectable to an arbitrary edge server and at least the type and unit of data collectable from the device for each type of the device; and a data format storage unit, the method comprising:
a data format setting step of setting a standard data format for the edge server used for receiving data collectable from the device connected to the edge server on the basis of the metadata corresponding to the type of the device stored in the data dictionary storage unit;
a data format examining step of examining a format in the standard data format set in the data format setting step; and
a data format registering step of registering the standard data format examined in the data format examining step with the data format storage unit.
